(19) United States
(12) Patent Application Publication
(10) Pub. No.: US 2021/0086638 A1
(43) Pub. Date: Mar. 25, 2021

(54) Planar Mechanism for Automated Connection of Electric Vehicles

(71) Applicant: ABB Schweiz AG, Baden (CH)

(72) Inventors: Gregory A. Cole, West Hartford, CT (US); Stefan Rakuff, Windsor, CT (US); William J. Eakins, Coventry, CT (US)

(73) Assignee: ABB Schweiz AG, Baden (CH)

(21) Appl. No.: 16/579,531

(22) Filed: Sep. 23, 2019

(51) Int. Cl. B60L 53/35; B60L 53/16

(52) U.S. Cl. CPC B60L 53/35; B60L 53/16

(57) ABSTRACT

A vehicle-side receptacle unit is described that is positionable on an underside of an electrical vehicle (EV) and a method for operating such unit. The vehicle-side receptacle facilitates hands-free connection of an automatic charging device including a charger electrical connector of a floor-positioned recharging unit. The automatic charging device includes a plurality of movable links including a distal link and a proximal link and a pivotal lift arm connected to the distal link coupled to the plurality of movable links and to the charger electrical connector. The plurality of movable links include rounded edges and the rounded edges are configured to minimize rotational interference between links during motion. The plurality of movable links include spring loaded casters. The plurality of movable links are coplanar when in a non-operational position and when in an operational position.

### TECHNICAL FIELD

The present disclosure relates to charging systems and methods for electric vehicles and, more particularly, to a connector for effecting an electrical connection between a vehicle charger and the vehicle.

### BACKGROUND OF THE INVENTION

Use of electrical vehicles (EV) is becoming increasingly popular due to the environmental benefits of removing pollution caused by fossil fuel burning vehicle engines from the environment, especially in densely populated urban environments. As with most mobile electrical devices, electrical vehicles carry electrical power storage devices or batteries, which provide power to the vehicle propulsion and other systems. As can be appreciated, the vehicle batteries require periodic recharging to provide consistent vehicle operation.

At present, electric vehicle recharging is a time consuming process that is typically carried out over long periods, for example, overnight or during prolonged periods when the electric vehicle is parked. Power dispensers include flexible conduits or wire bundles that include a connector at their end, which plugs into a vehicle receptacle and then begins the transfer of power from the dispenser the vehicle's battery.

Traditional vehicle power dispensers operate at around 200-240 Volt AC, and transfer about 30 Amp of electrical power into a vehicle. As a consequence, providing a full charge to a vehicle can take up to 10 hours or more. With the increase in popularity of electric vehicles, faster charging solutions are required, especially for vehicles that operate for more than 12 hours per day such as emergency vehicles, public transportation, professional vehicles and the like. With faster charging there is a need to isolate the user from the high voltages and high current of chargers by fast charging via the undercarriage of the EV with an automatic charging device (ACD) or the like. Further, in autonomous driving vehicles should be able to autoconnect, because charging stations may then be placed in unmanned locations that are undesirable to a user. Also, an automatic connection/disconnection system will allow a single charger to charge multiple vehicles without human presence (i.e., if you go to a baseball game, your vehicle can plug in and when it is done charging, the charger is not locked into being utilized until someone disconnects it.

Many ACD mechanism designs exist, but many fail to provide adequate protection against moisture, dust and debris ingress. The overall height of the ACD mechanism should be smaller than the EV ground clearance is another challenge to overcome. The ACD mechanism must also be resistant to accidental drive-over events. Finally, the ACD mechanism must lend itself to occupy only a minimum footprint when not in use.

### BRIEF SUMMARY OF THE INVENTION

The invention provides a vehicle-side receptacle unit is described that is positionable on an underside of an electrical vehicle (EV) and a method for operating such unit. The vehicle-side receptacle facilitates hands-free connection of an automatic charging device including a charger electrical connector of a floor-positioned recharging unit. The automatic charging device includes a plurality of movable links including a distal link and a proximal link and a pivotal lift arm connected to the distal link coupled to the plurality of movable links and to the charger electrical connector. The plurality of movable links include rounded edges and the rounded edges are configured to minimize suspension feedback. The plurality of movable links include spring loaded casters. The plurality of movable links are coplanar when in a non-operational position and when in an operational position.

The invention also provides a hands-free method, carried out by an automatic charging device directed to an underside of an electrical vehicle (EV), for achieving an electrical connector mating between a vehicle-side electrical connector and a charger electrical connector of a floor-positioned recharging unit. The automatic charging device includes a plurality of movable links including a distal link and a proximal link; and a pivotal lift arm connected to a distal link of the plurality of movable links and to the floor unit electrical connector. The method includes positioning vehicle-side electrical connector over the charger electrical connector; establishing a proper mating positioning of the connectors; and mate the positioned connectors to establish a functional electrical recharging path between the floor unit and the EV without physical user intervention.

### BRIEF DESCRIPTION OF THE SEVERAL VIEWS OF THE DRAWING(S)

FIG. 1 is a perspective view of an electric vehicle (EV) charging environment 2 according to an embodiment of the disclosure;

FIG. 2 is a flowchart of a method for underside charging of EVs according to an embodiment of the disclosure;

FIG. 3 is a perspective view of a linkage mechanism in a closed position according to an embodiment of the disclosure;

FIG. 4 is a perspective view of a linkage mechanism in an opened position according to an embodiment of the disclosure;

FIGS. 5A to 5C illustrate a sequence of positions during a sequence of operational steps according to an embodiment of the disclosure;

FIG. 6 is a plan view of a linkage mechanism proximal an EV according to another embodiment of the disclosure; and

FIG. 7 is a flowchart of a method for recharging an EV containing a vehicle-side receptacle unit positioned on an underside of the EV according to an embodiment of the disclosure.

### DETAILED DESCRIPTION OF THE INVENTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

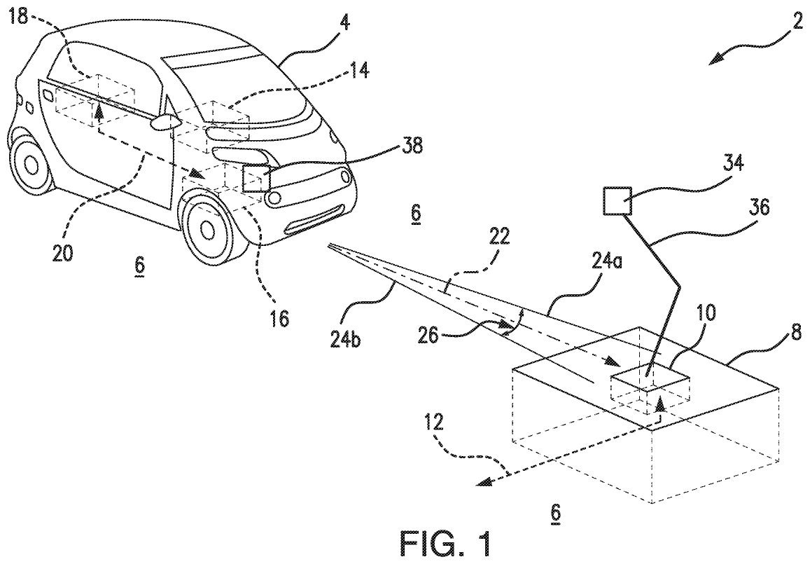

FIG. 1 is a perspective view of an electric vehicle (EV) charging environment 2 according to an embodiment of the disclosure. In the example shown in FIG. 1, an EV 4 is positioned on a ground surface 6. EV 4 is a car, as shown in FIG. 1. Alternatively, EV4 may be a truck, a motorcycle, a moped, a truck or bus, a farm implement or any other on- or off-highway vehicle. In the example shown, ground surface 6 is a floor of a garage of a home or business. Alternatively, ground surface 6 may be a surface of a parking lot. Environment 2 includes a floor unit 8. Floor unit 8 is positioned on or at least in part beneath ground surface 6. Depending on application, and also on the ground clearance of the vehicle, the floor unit 8 may be fully or partially disposed beneath the ground surface, or may alternatively be disposed on the ground surface, for example, when installed on existing floors. Floor unit 8 includes a connector unit 10. At least a portion of connector unit 10 faces and is exposed or exposable to ground surface 6. Floor unit 8 includes a connector unit 10 that is operatively coupled to or associated with an electric power source (e.g., a utility grid, not shown in FIG. 1), either directly or through a transforming or conditioning device such as a transformer. A first electric power flow 12 can thus be selectively enabled between power source and floor unit 8, including to connector unit 10.

EV 4 includes a drivetrain 14 providing motive power to the EV 4 for driving. EV 4 includes a vehicle unit 16 and at least one power storage device such as a battery 18. Battery 18 is operatively coupled to drivetrain 14 for providing electric power thereto to enable providing motive power for EV 4 selectively during operation. Structures and systems of the EV 4 that accomplish the provision of power to the drivetrain 14 selectively by an operator (now shown) of the EV 4 are omitted for simplicity. At least a portion of vehicle unit 16 faces and is exposed or exposable to ground surface 6. It is noted that, while the EV 4 is shown in one orientation as it approaches the floor unit 8, any orientation of approach is also contemplated. Vehicle unit 16 is operatively coupled to battery 18 to provide an interface for providing electrical power to charge the battery 18. A second electric power flow 20 is thus enabled between vehicle unit 16 and battery 18.

In the EV charging environment 2 shown in FIG. 1, EV 4 is being driven and approaches the floor unit 8 including connector unit 10. A driver of EV 4 (e.g., a human driver and/or an autonomous vehicle driving system, not shown in FIG. 1) steers or otherwise controls the EV 4 to floor unit 8 including connector unit 10 along a centerline path 22. As shown in FIG. 1, centerline path 22 extends from EV 4 to at least approximately a center point of connector unit 10 proximal ground surface 6. Based on the particular dimensions and other specifications of EV 4, floor unit 8 including connector unit 10, and/or vehicle unit 16, an approach path of EV 4 to floor unit 8 including connector unit 10 may deviate from the target centerline path 22 by an allowable deviation 24. The allowable deviation may be in any direction, including but not limited to a horizontal or vertical direction. Allowable deviation 24 includes a driver side deviation 24a and a passenger side deviation 24b. An allowable misalignment 26 is defined between lines defining driver side deviation 24a and passenger side deviation 24b. In three dimensions, the misalignment 26 may form a conical area that accounts for height of ground clearance of the vehicle, as well pitch, yaw and roll of the vehicle's trajectory during the approach to the floor unit 8, and also during the connection and charging operations.

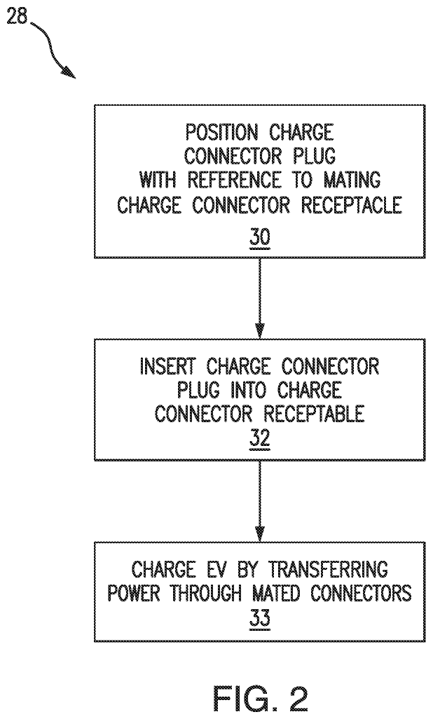

FIG. 2 is a flowchart of a method 28 for underside charging of the EV 4 according to an embodiment of the disclosure. In an example, method 28 is implemented and performed, at least in part, by a mechanical and/or electrical linkage system 36, which rises up from the floor 6 from the connector unit 10 and includes or carries an electrical connector 34. The electrical connector 34 matingly engages a connector 38 associated with the vehicle unit 16 when the EV 4 is stationary over the floor unit 8 for charging.

Referring to FIG. 2, method 28 includes positioning at 30 the connector 34 on the floor unit 8 with reference to connector 38 on the EV 4 using linkage 36. Such placement may be carried out automatically. Method 28 further includes inserting at 32 the connector 34 into connector 38, and initiating a charging process at 33. When the connectors 34 and 38 are mated, a flow of electrical power from the power flow 12 is allowed to be transmitted from the floor unit 8 to the vehicle unit 16, and from there to the battery 18 to charge the battery. A breakable electrical connection between the connectors 34 and 38 is included in this power flow path that charges the battery 18. As can be appreciated, the environment in which the connectors 34 and 38 is harsh because one or both sides of the connectors 34 and 38 are exposed to the environment, road debris, etc. Moreover, the connectors 34 and 38 are advantageously compact to enable or facilitate manual and/or automatic coupling for charging the battery 18.

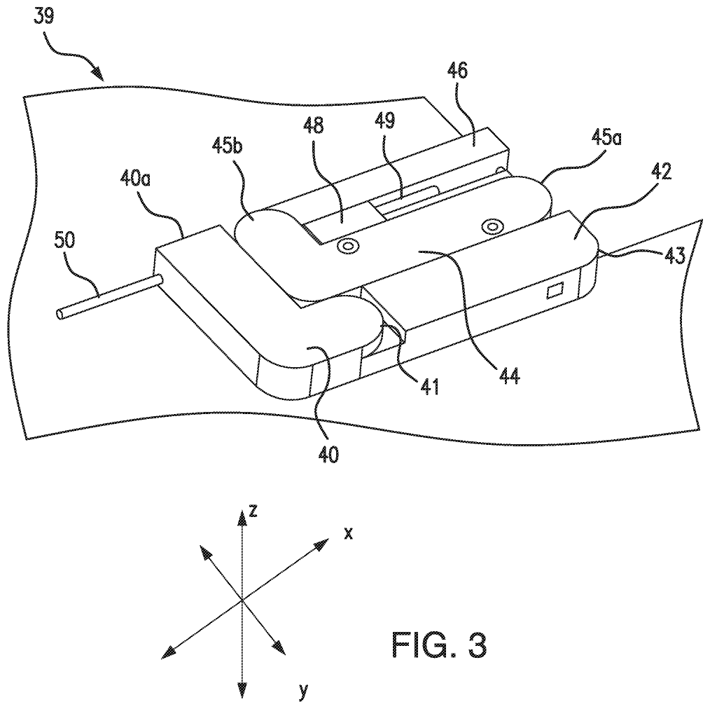

Referring to FIG. 3, in certain embodiments, connector 34 and linkage mechanism 36 comprises a compact automatic charging device (ACD) mechanism 39 is configured to position a charge connector 48 similar to connector 34 and charge cable 50 for automatic electric vehicle (EV) connections. The ACD 39 includes the linkage mechanism 36 having a plurality of links 40, 42, 44 and 46 that are connected via revolute joints at 41, 43, 45a and 45b. Each revolute joint contains an actuator or servo (not shown) to control motion. Each link contains proximity sensors to detect the EV 4 and to align connector 48 with connector 38. The proximity sensor may be configured to connect to a control system configured to receive and interpret information from a proximity and localization sensing system (proximity sensors) configured to record this information for calibration and for post operational analysis. In some embodiments, the control and the proximity and localization sensing systems are configured to record all available system information about operation and leveraging such recorded information to learn about operating performance and habits (i.e., when the device connects, how often, how long it takes to connect, the location and pose of the lift arm, the average deviation from target position, and the like).

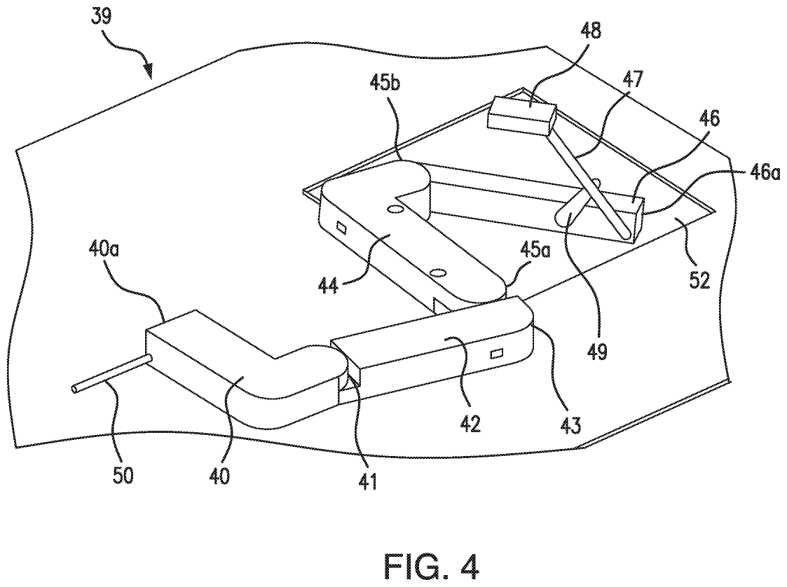

The end of the final or last link 46 holds a height (z-axis) adjustment stage 49 comprising a pivotable support arm 47 attached to the connector 48 configured to move connector 48 in the z-axis direction as shown in FIG. 4. The ACD mechanism 39 also comprises four planar rotation links 40, 42, 44 and 46 coupled to a compliant lift mechanism at 49. The configuration enables a low planar profile, a compact and permanently installed size envelope, coupled with complete robustness to drive-over events and contamination avoidance. In other words, links 40, 42, 44 and 46 remain in the same plane when in a non-operational position and in an operational position (e.g., see FIGS. 3 and 4).

Referring to FIG. 4, the ACD mechanism 39 includes a four degree of freedom comprised entirely of sealed rotary joints 41, 43, 45a and 45b for positioning an electrical connection to an underbody vehicle inlet at 38. In certain embodiment, the plurality of links 40, 42, 44 and 46 are configured to move in the x-y plane about pivot axes or joints at 41, 43, 45a and 45b. The motion chain is defined such that the charge connector (plug head) 48 can be presented to the vehicle inlet at 38 by controlling all of the x-, y- and z-axis positions through angular motions of the joints 41, 43, 45a and 45b.

The motion chain of the ACD mechanism 39 is structured such that at any point, if a load is applied to a top surface of the ACD mechanism 39, there is a solid pathway to ground 6 thereby protecting all of the ACD mechanism 39, such as a drive over event of the EV 4. The plurality of links 40, 42, 44 and 46 of the ACD mechanism 39 are supported by spring loaded casters (not shown) when the links move across the ground 6 and bottom out to ground 6 taking and distributing the load of a drive over event.

The ACD mechanism 39 can be constructed at low coast, mass produced components, with a completely compliant connection. The links 40, 42, 44 and 46 are configured with rounded corners/edges at 41, 43, 45a and 45b to minimize rotational interference between links during motion and to allow for compactness when stowed away.

The ACD mechanism 39 is constructed in such a manner that when it is driven over by an EV 4, there is a direct solid connection between tire and ground 6, distributing the load of the EV 4 through solid link pieces 40, 42, 44 and 46 without placing forces on any assemblies and/or mechanisms. The kinematic chain of the ACD mechanism 39 allows for targeting the EV inlet at 38 including yaw alignment, which other automatic connection solutions lack.

In some embodiments, link 40 may be directly connected to charge cable 50 at a distal end 40a while at a proximal end at 41 is connected to link 42 for pivotal motion. Link 42 is connected to link 44 at edges 43, 45a for pivotal motion. Link 44 is connected to link 46 at edge 45b for pivotal motion. Pivotal support arm 47 is connected to a distal end 46a of link 46. The compliant lift mechanism 49 is pivotably connected to pivotal support arm 47 and link 46 to lift charge connector 48 in the z-axis direction to connect with connector 38 for charging EV 4.

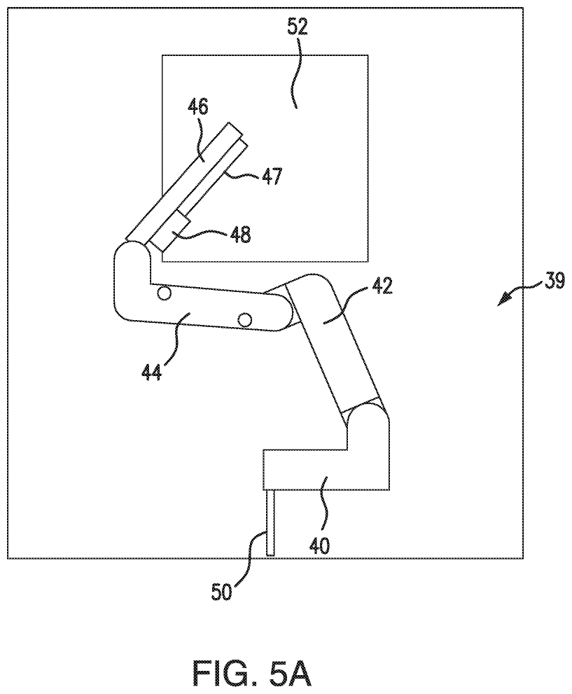

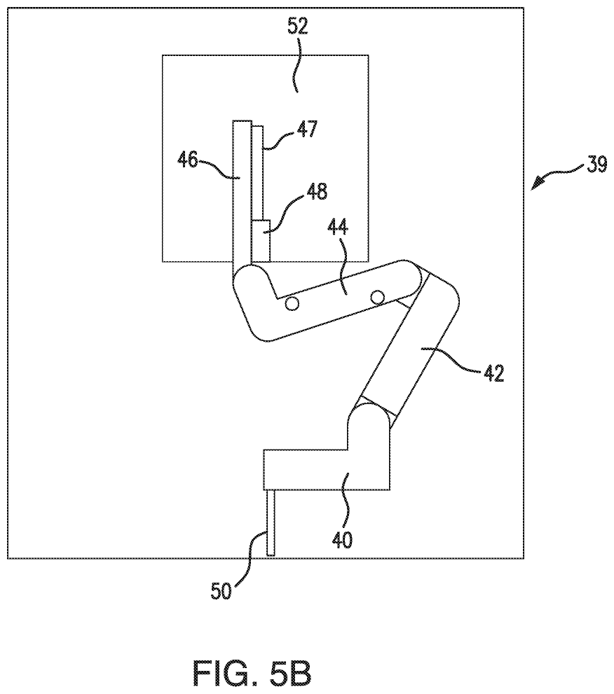

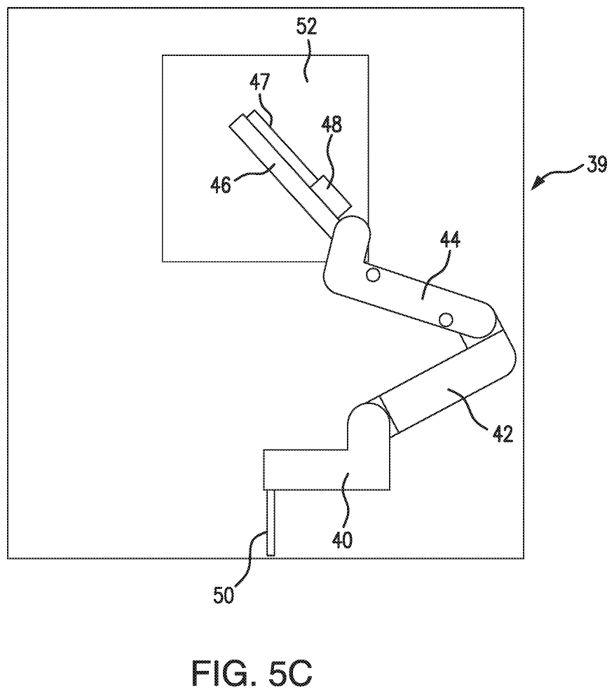

Referring to FIGS. 5A to 5C, the ACD mechanism 39 is configured to position the charge cable 50 and connector 48 for automatic connection with an EV underbody connector 38. The ACD mechanism 39 must be able to position the charge connector 48 to any given location within a virtual charging zone 52 beneath the EV 4. This charging zone 52 is a virtual box with a footprint of about 500 mm×500 mm in the x- and y-axis directions. The vertical (z-axis) range of the charging zone is about from 90 mm to 260 mm. Angular positioning variances include a ±15° yaw angle.

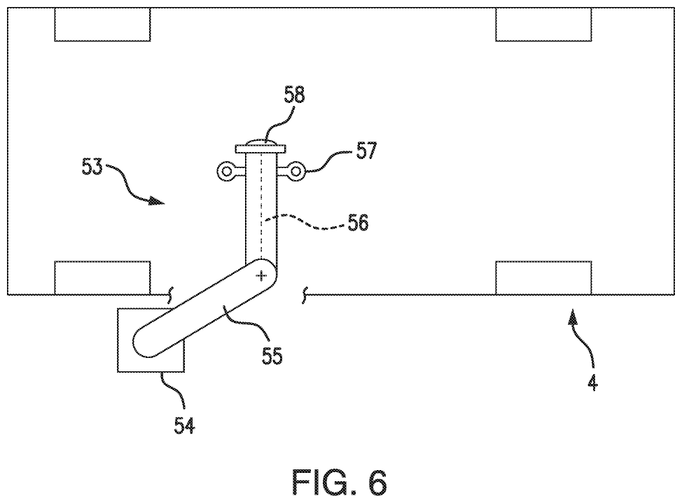

FIG. 6 is a plan view of an alternative embodiment of an ACD linkage mechanism 53 including a mount 54 disposed outside the perimeter of an EV 4 configured to reach beneath the EV 4. Linkage mechanism 53 also includes a plurality of pivotal links 55, 56 coupled together for motion. In certain embodiments, link 56 includes a distal end 58 and an electrical connector 57 disposed proximal the distal end 58. Electrical connector 57 is configured to mate with connector 38 of the EV 4.

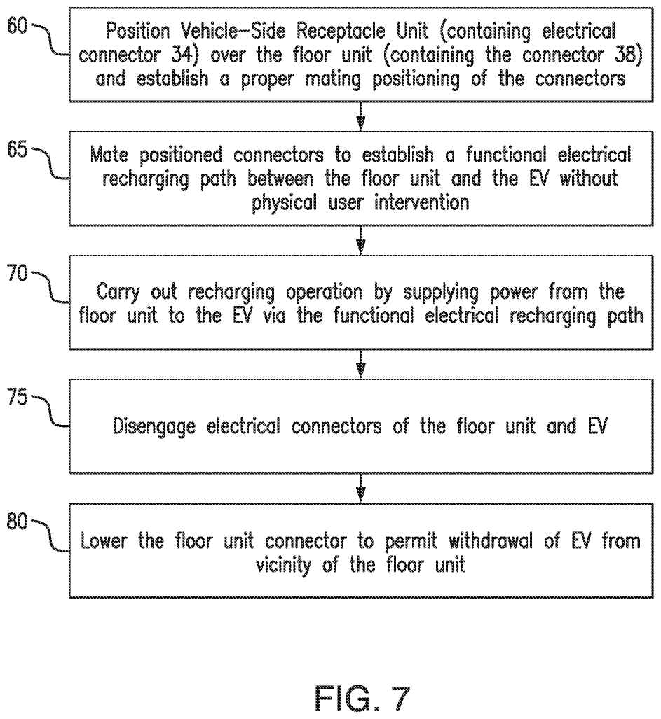

Referring to FIG. 7, a flowchart summarizes steps for a method for performing an underside recharging of the EV 4 according to an embodiment of the disclosure. In an illustrative example, the method is implemented and performed, at least in part, by the linkage system 36, which raises the electrical connector 34 from a retracted position near the floor level at 6 and cooperatively interacts with physical features/elements of the vehicle-side receptacle unit 16 to affect a physical mating of complementary connective structures of the electrical connector 34 (e.g., plug prongs) and corresponding electrically conductive surfaces (female receptacle electrodes) of the electrical connector 38 of the vehicle-side receptacle unit 16.

With continued reference to FIG. 7, referring to the particularly identified stages of a recharging operation carried out in accordance with the environment depicted in FIG. 1, during 60 the EV 4 is positioned over the floor unit 8 (within a range of acceptable relative positions) and the electrical connector 34 and linkage 36 are raised and guided such that the electrical connector 34 is placed in a mating position in relation to the electrical connector 38 of the EV 4.

After establishing a mating positioning of the electrical connector 34 in relation to the electrical connector 38, during 65 a mating is affected with regard to the complementary electrically conductive electrodes/surfaces of the connector 34 and the connector 38. By way of example, both the electrical connector 34 and the electrical connector 38 include corresponding flush/surface contacts. However, another suitable arrangement utilizes male/female prong/receptacle connectors. For example, the electrical connector 38 is a female/receptacle and the electrical connector 34 is a multi-pronged plug, and the mating of the connectors is achieved by inserting the prongs of the connector 34 into the receptacle openings of the connector 38. Alternatively, the electrical connector 34 comprises the female/receptacle and the electrical connector 38 comprises a multi-pronged plug. The positioning and mating of the electrical connector 34 with the electrical connector 38, as will be explained further herein below, is carried out without a user physically intervening.

After mating the connectors, during 70, power is supplied by the floor unit 8 to the vehicle-side receptacle unit 16 of the EV 4 to carry out a recharging operation of the battery 18. Thereafter, during 75, the electrical connector 34 and the electrical connector 38 are disengaged, and during 80 the connector 34 is lowered to permit withdrawal of the EV 4 from the vicinity of the floor unit 8.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An automatic charging device positionable to access an underside of an electrical vehicle (EV) that facilitates hands-free connection of a vehicle-side electrical connector with a charger electrical connector, the automatic charging device comprising:
a plurality of movable links including a distal link and a proximal link; and
a pivotal lift arm connected to the distal link coupled to the plurality of movable links and to the charger electrical connector,
wherein the charger electrical connector is arranged to move in a direction of the vehicle-side electrical connector to facilitate a mating of corresponding electrical contacts of the vehicle-side electrical connector and the charger electrical connector.

2. The automatic charging device of claim 1 wherein the plurality of movable links further comprises rounded edges configured to minimize rotational interference between links during motion.

3. The automatic charging device of claim 2 wherein the plurality of movable links include spring loaded casters.

4. The automatic charging device of claim 2 wherein the plurality of movable are coplanar when in a non-operational position and when in an operational position.

5. The automatic charging device of claim 1 wherein the plurality of movable links are configured to move in the x-y planar directions via actuators.

6. The automatic charging device of claim 1 wherein the pivotal lift arm and the charger electrical connector are configured to move in the z-axis planar direction.

7. The automatic charging device of claim 1 wherein the plurality of movable links include proximity sensors to detect the EV and to align the charger electrical connector to the vehicle-side electrical connector.

8. The automatic charging device of claim 7 wherein the proximity sensors are configured to align the charger electrical connector to the vehicle-side electrical connector.

9. The automatic charging device of claim 7, further comprising a control system configured to receive and interpret information from the proximity sensors and configured to record information for calibration and post-operational analysis.

10. A hands-free method, carried out by an automatic charging device directed to an underside of an electrical vehicle (EV), for achieving an electrical connector mating between a vehicle-side electrical connector and a charger electrical connector of a floor-positioned recharging unit, where the automatic charging device comprises:
a plurality of movable links including a distal link and a proximal link; and
a pivotal lift arm connected to the distal link coupled to the plurality of movable links and to the charger electrical connector,
wherein the method comprises:
positioning vehicle-side electrical connector over the charger electrical connector;
establishing a proper mating positioning of the connectors; and
mate the positioned connectors to establish a functional electrical recharging path between the charger electrical connector and the EV without physical user intervention.

11. The method of claim 10, further comprising supplying power from the charger electrical connector to the EV via the functional electrical recharging path.

12. The method of claim 10, further comprising disengaging electrical connectors of the charger electrical connector and the EV.

13. The method of claim 10, further comprising lowering the charger electrical connector to allow withdrawal of the EV from the vicinity of the charger electrical connector.

14. The method of claim 10 wherein the plurality of movable links further comprises rounded edges.

15. The method of claim 14 wherein the rounded edges are configured to minimize rotational interference between links during motion.

16. The method of claim 10 wherein the plurality of movable links include spring loaded casters.

17. The method of claim 10 wherein the plurality of movable links are coplanar when in a non-operational position and when in an operational position.

18. The method of claim 10 wherein the plurality of movable links are configured to move in the x-y planar directions.

19. The method of claim 10 wherein the pivotal lift arm and the charger electrical connector are configured to move in the z-axis planar direction.

20. The method of claim 10 wherein the plurality of movable links include proximity sensors to detect the EV and to align the charger electrical connector to the vehicle-side electrical connector.

21. The method of claim 10 wherein the proximity sensors are configured to align the charger electrical connector to the vehicle-side electrical connector.
